(19) United States
(12) Patent Application Publication
(10) Pub. No.: US 2024/0084864 A1
(43) Pub. Date: Mar. 14, 2024

(54) COVERING PLATE AND BRAKE CALIPER BODY ASSEMBLY WITH A COVERING PLATE

(71) Applicant: Brembo S.p.A., Curno (IT)

(72) Inventors: Cristian CRIPPA, Curno (IT); Gianfranco DELL'ACQUA, Curno (IT); Sara ARRAGONI, Curno (IT)

(21) Appl. No.: 18/463,656

(22) Filed: Sep. 8, 2023

(30) Foreign Application Priority Data
Sep. 9, 2022 (IT) 102022000018417

(51) Int. Cl. F16D 65/00

(52) U.S. Cl. CPC F16D 65/0081; F16D 65/0068; F16D 2055/0016

(57) ABSTRACT

An assembly may have at least one plate and a caliper body. The plate may have at least one protuberance which, when the plate is separated from the brake caliper body, extends in a cantilevered manner from the plate. The caliper body may also have at least one housing accommodating the protuberance, which can take a plurality of positions. The assembly may also have connecting means, which move from a disengaging position, which allows modifying the relative position between the protuberance and the housing, to an engaging position, in which the connecting means make the protuberance integral with the housing. The connecting means move from the disengaging position to the engaging position by means of a threaded member.

### FIELD

The present invention relates to a covering plate, also known as aesthetic plate or “logo plate”, “aesthetic skin plate”, “protective cover” or “guard screen”, as well as to a brake caliper body and covering plate assembly associated therewith.

In particular, the present invention relates to a covering plate connectable to a brake caliper body, and more specifically to a covering plate mounted to the brake caliper body.

### FIELD

In a disc brake, the brake caliper is generally arranged straddling a brake disc mounted to the hub of a vehicle wheel. The brake caliper usually comprises a caliper body accommodating the brake pads, and actuators for pushing the pads against the disc to achieve the braking action on the vehicle.

The brake caliper body is an unsprung mass of the vehicle and is designed to be as light as possible and at the same time as resistant as possible to the deformation actions generated by the braking action on the brake disc.

These brake caliper bodies are often visible on the side facing the spokes of the wheel rims of the vehicle or entirely visible, in the case of motorcycles.

Various styling options are requested by vehicle manufacturers when ordering the disc brakes as described above. Most of them require the addition of aesthetic parts that condition the styling, e.g., parts of the caliper body or plates showing the vehicle manufacturer's logo. Moreover, since disc brakes are installed so as to be visible and identifiable from the outside of the vehicle, as mentioned through the spokes of the rims which leave increasingly large windows, it is desirable to install a plate or label with a manufacturer's logo or a logo with other desired advertising effect.

Solutions of this type are known, for example, from U.S. Pat. No. 9,046,143B2, KR20170083288A, U.S. Ser. No. 10/808,780B1, U.S. Ser. No. 10/378,597, EP1881472B1, US2004074716A1, JP5715932B2, U.S. Ser. No. 10/066,687B2, U.S. Ser. No. 10/228,033, U.S. Ser. No. 10/378,597, U.S. Ser. No. 10/228,033, U.S. Pat. No. 8,616,349, U.S. Ser. No. 10/378,597, U.S. Ser. No. 10/228,033, U.S. Pat. No. 8,616,349, EP2018490B1.

In particular, WO2020231145A1 to Mando Corp. describes a “logo plate” made of plastic material in which opposite hooks fit into opposite caliper body housings. This solution does not ensure that a cross action of the opposite hooks is applied and, moreover, it does not allow a preload action on the hooks, which will keep the plate firmly coupled to the caliper body over time. Especially, the present solution does not ensure that the disassembly of the plate from the caliper body is prevented except in a complex manner. The action of the hooks is directed according to mutually parallel directions, making the overall action on the plate uncertain and imprecise. Moreover, even if a hook is inserted as an undercut into a housing of the caliper body, in this solution it is sufficient to lift the hook with a screwdriver even from one side to remove the plate.

Other solutions are known from US2009152056A1, which shows the solution of a plate which is coupled as an undercut but not so as to prevent the even accidental extraction thereof from the caliper body, and from US2013291418A1 to Lucas Automotive GmbH, which shows a dissymmetric solution and which is designed explicitly and specifically to be easy to remove, thus suggesting a solution which serves an opposite purpose to that sought to be solved here.

Document EP1881472B1 shows an aesthetic plate connected to the caliper body by means of pins inserted into holes by interposing anti-extraction springs.

Document KR20170083288A shows an aesthetic plate connected to the caliper body by a pin locked by means of a screw inserted into a through slot of the pin and then locked into a threaded housing transverse to the pin and provided in the caliper body. Similar solutions are known from U.S. Pat. No. 9,046,143B2, U.S. Ser. No. 10/066,687B2, U.S. Ser. No. 10/228,033, U.S. Ser. No. 10/808,780B1, U.S. Ser. No. 10/378,597, U.S. Ser. No. 10/228,033, U.S. Pat. No. 8,616,349.

Therefore, the need is still felt to couple a covering plate to the caliper body in an easy to mount but at the same time safe manner, i.e., which does not lose the coupling to the caliper body in use.

Moreover, although it is known to fix the covering plates in precise positions, the construction tolerances and various assembly situations, especially when replacing the covering plate or servicing the disc brake, lead to difficulties in mounting, and in particular in the coupling between the covering plate and the brake caliper body. This need is felt more if, during the maintenance of the caliper, the covering plate must be removed causing even small deformations in the plate or the mounting parts thereof, making its subsequent assembly difficult if not impossible.

### SUMMARY

It is the object of the present invention to provide a brake caliper body and covering plate assembly, which is easy to manufacture and install while ensuring the maximum certainty that the covering plate will not accidentally separate from the brake caliper body when using the brake caliper but which is positionable in an adjustable manner, i.e., in various relative positions between the covering plate and the brake caliper body.

These and other objects are achieved by an assembly according to claim 1, as well as by a mounting method according to claim 13.

Some advantageous embodiments are the subject of the dependent claims.

From the analysis of this solution, it was found that the suggested solution allows simplifying the covering plate and simultaneously achieving a greater safety of the connection between the covering plate and the brake caliper body.

### DESCRIPTION OF THE FIGURES

Further features and advantages of the covering plate and the brake caliper body and covering plate assembly are given by way of non-limiting indication, with reference to the accompanying drawings, in which:

FIG. 1 is an axonometric view of a brake caliper, provided with an assembly according to a first embodiment of the present invention, mounted straddling a brake disc, shown here in dashed lines, on the wheel side;

FIG. 2 is an axonometric view of the caliper in FIG. 1 from the outer radial and axial side on the vehicle side;

FIGS. 3 and 4 are circumferential and axonometric section views, taken along a plane, containing the radial and axial directions, of the brake caliper in FIG. 1, highlighting a covering plate connected to the brake caliper body;

FIG. 5 is an axonometric view of the brake caliper in FIGS. 3 and 4 with separate parts, where the covering plate is separated from the brake caliper body;

FIG. 6 is an axonometric view of the covering plate from its side facing the brake caliper body;

FIGS. 7 and 8 are axonometric views of a detail of the covering plate in FIG. 6 from the outer radial and axial directions, as well as of an enlargement to highlight how the coupling screw abuts in the protuberance groove;

FIG. 9 is an axonometric section view, taken along a plane containing the radial and circumferential directions, of a detail of the covering plate in FIG. 8 in which the coupling screw and the coupling protuberance are sectioned;

FIGS. 10, 11, 12, 13, 14 show outer radial, inner radial, lateral (i.e., circumferential), frontal (i.e., axial toward the vehicle), and rear (i.e., axial toward the outside of the vehicle) views of the covering plate alone;

FIG. 15 is an axonometric view of a brake caliper, provided with an assembly according to a second embodiment of the present invention, mounted straddling a brake disc, shown here in dashed lines, on the wheel side;

FIGS. 16 and 17 are a circumferential view and an axonometric views sectioned along a plane, respectively, of the brake caliper in FIG. 15, containing the radial and axial directions, highlighting a covering plate connected to the brake caliper body;

FIG. 18 is an axonometric view of the brake caliper in FIGS. 16 and 17 with parts separated, where the covering plate is separated from the brake caliper body;

FIG. 19 is an axonometric section view, taken along a plane containing the radial and axial directions, of the covering plate at the coupling protuberance of which the tightening screw is screwed with a sleeve interposed;

FIG. 20 and FIG. 21 are an axonometric view of the assembly in FIG. 19 and a detail with parts separated, respectively, in which the coupling protuberance, the sleeve, and the tightening screw are spaced apart from one another;

FIG. 22 is an axonometric section view taken along a plane containing the radial and axial directions, a detail of the brake caliper body highlighting the caliper housing.

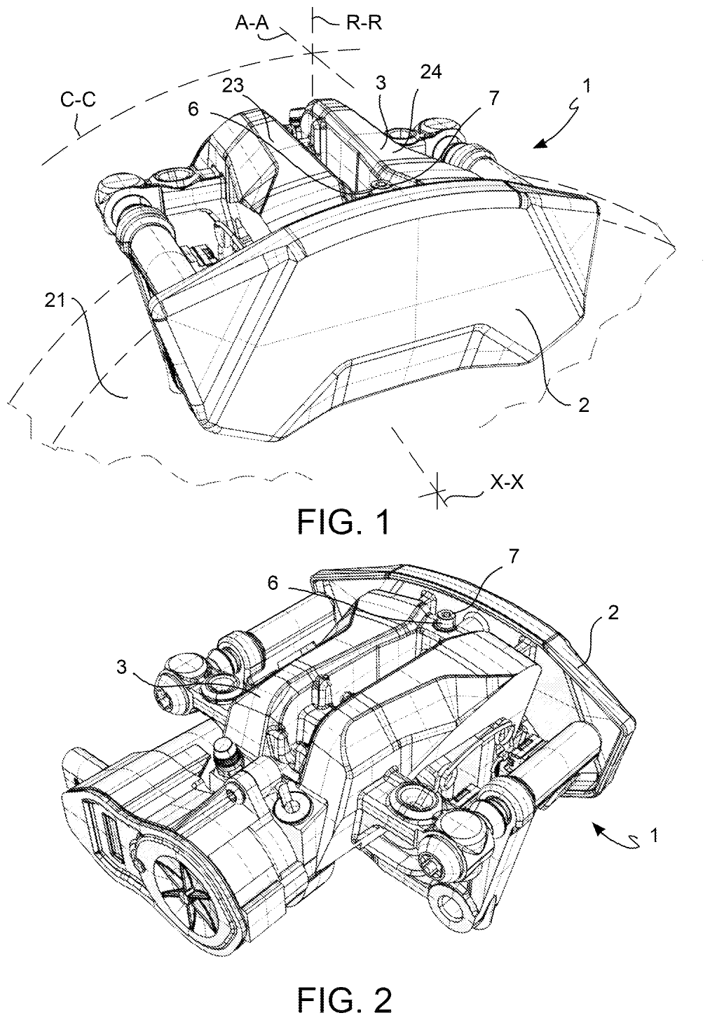

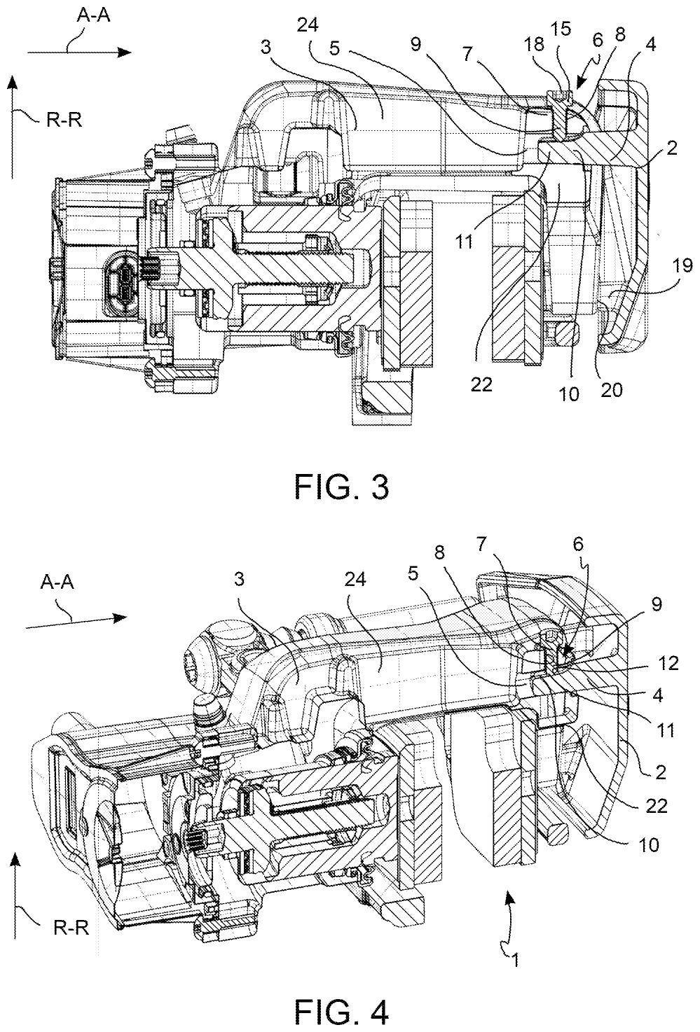

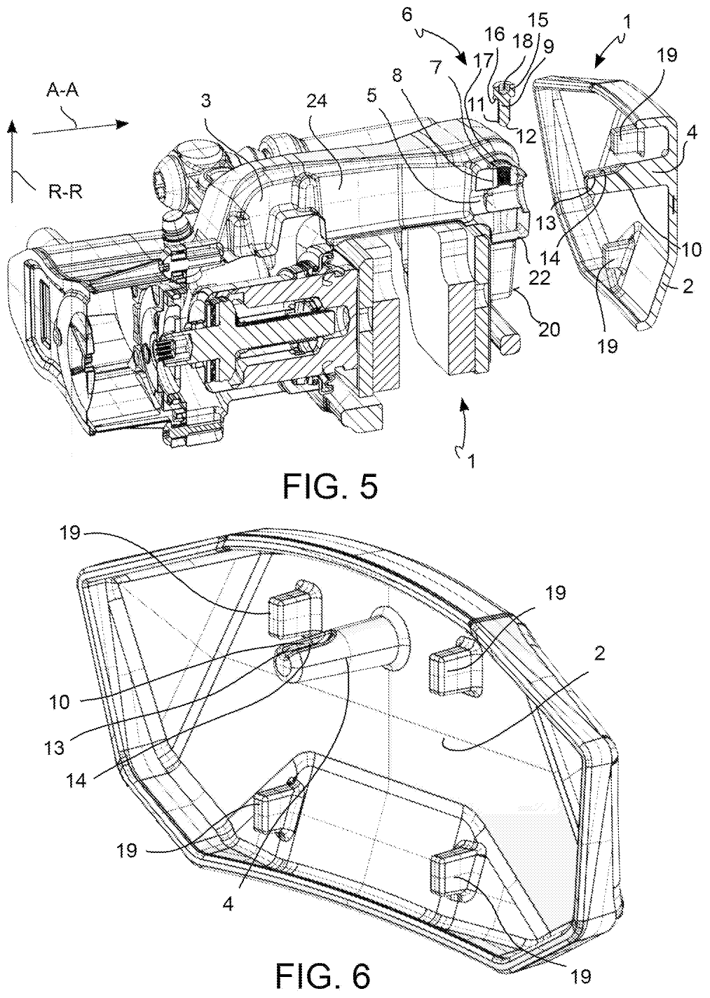

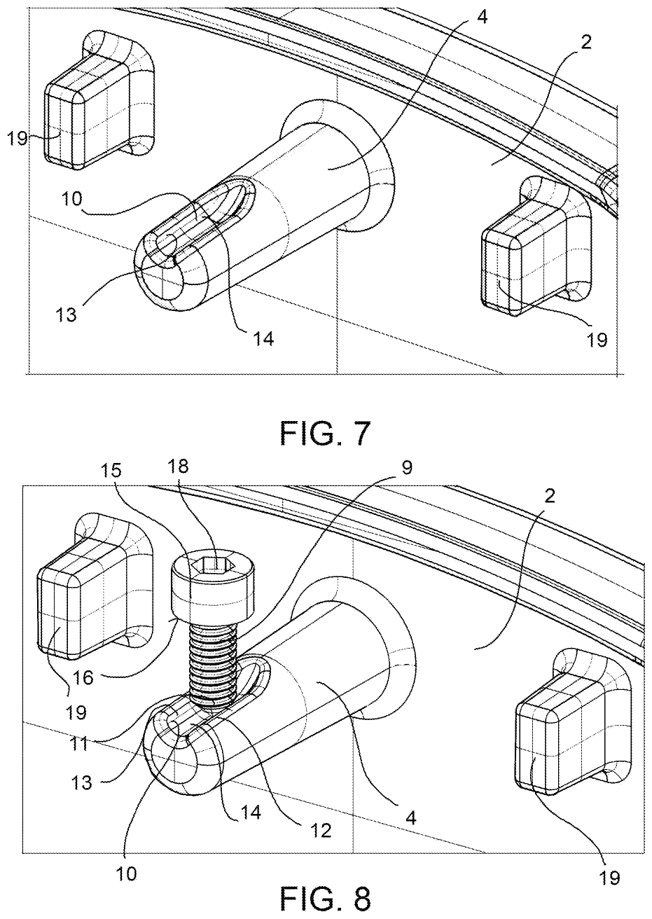

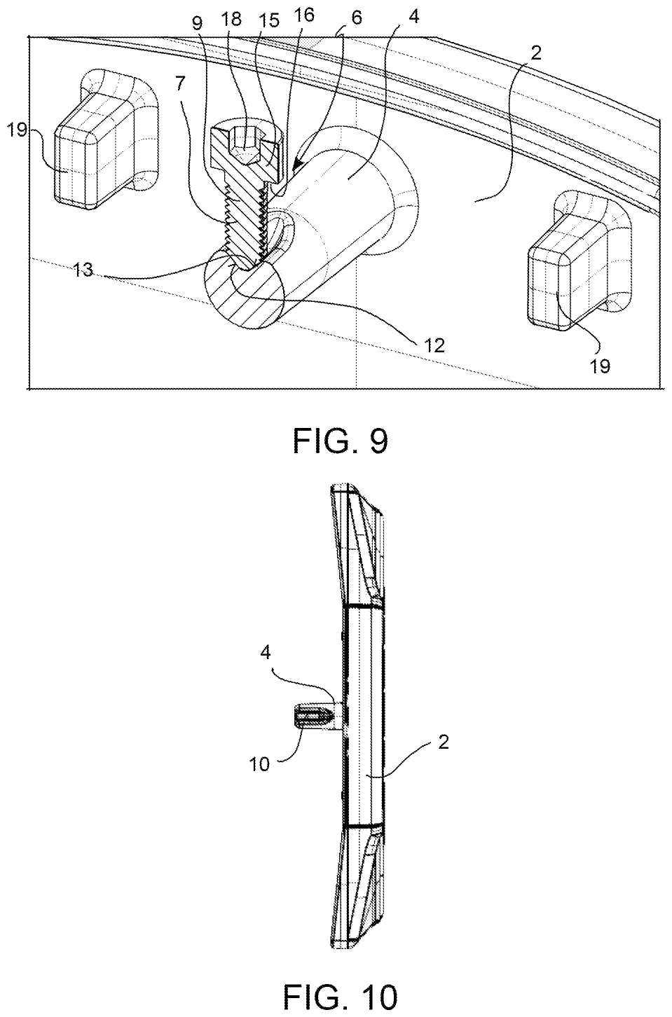

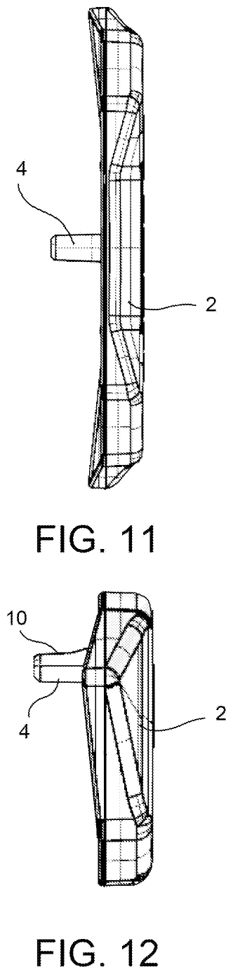

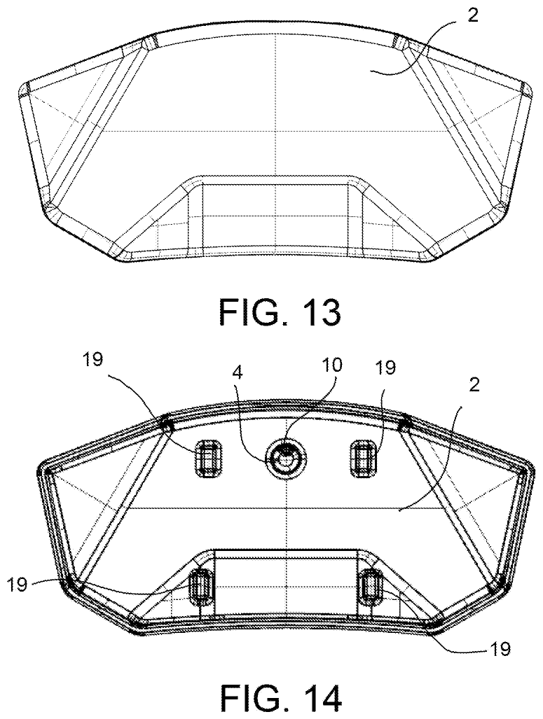

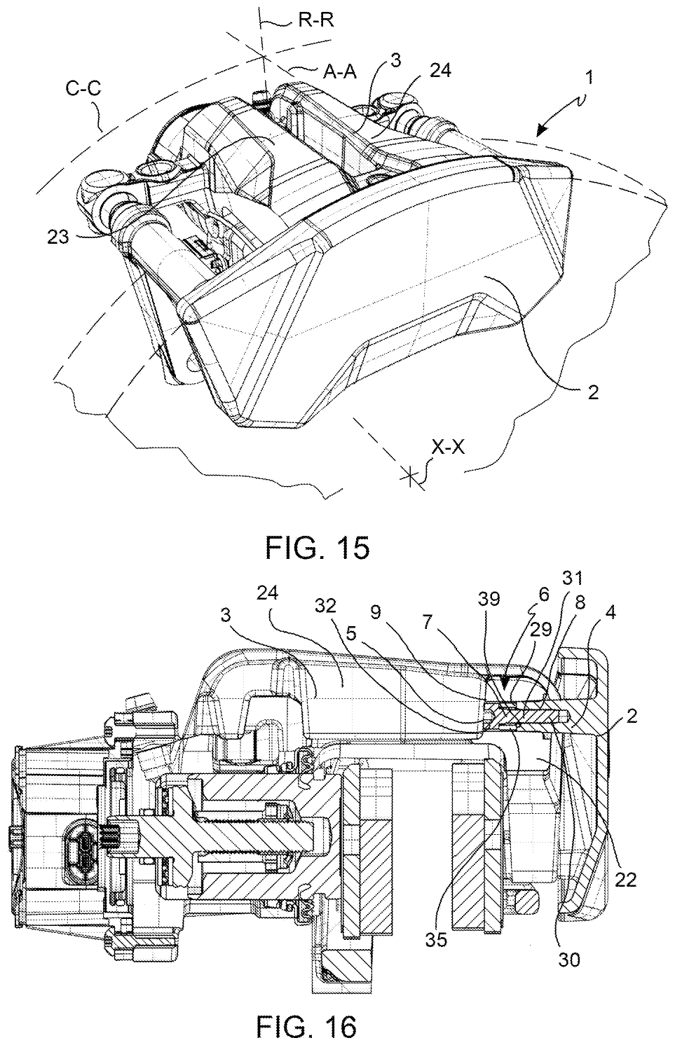

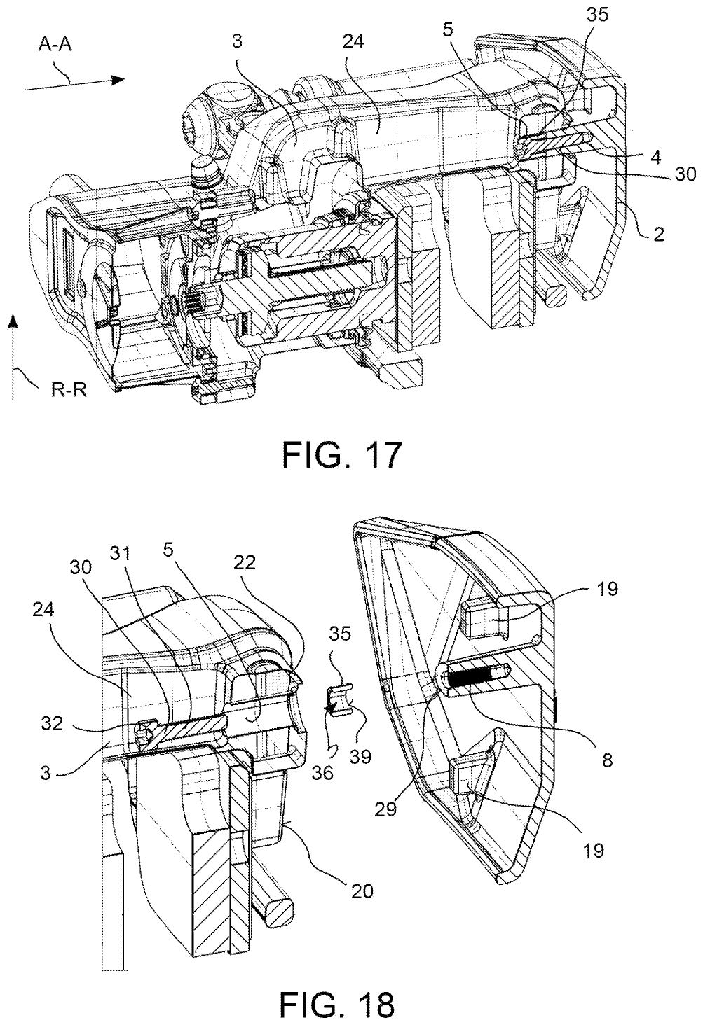

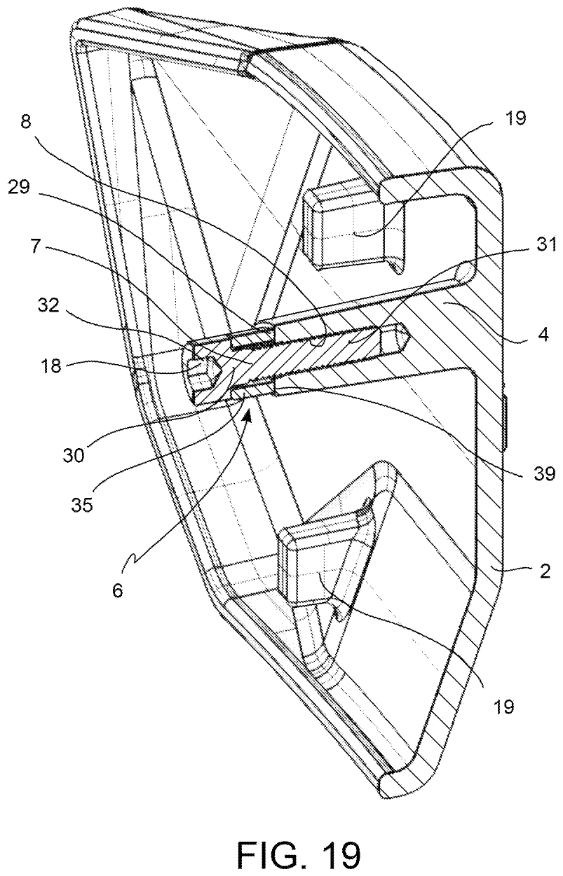

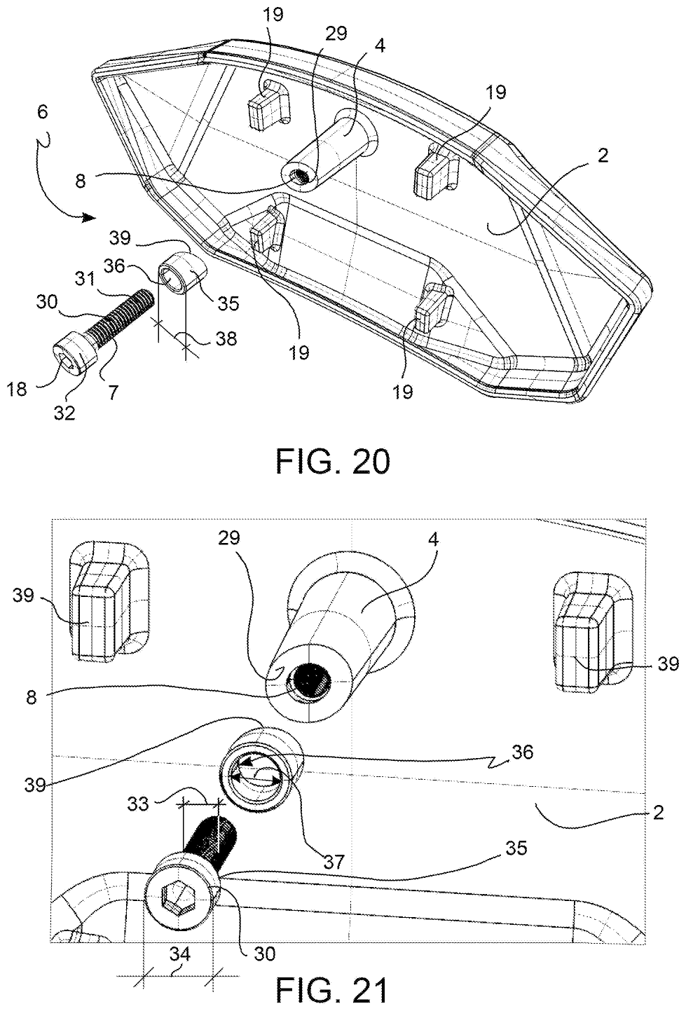

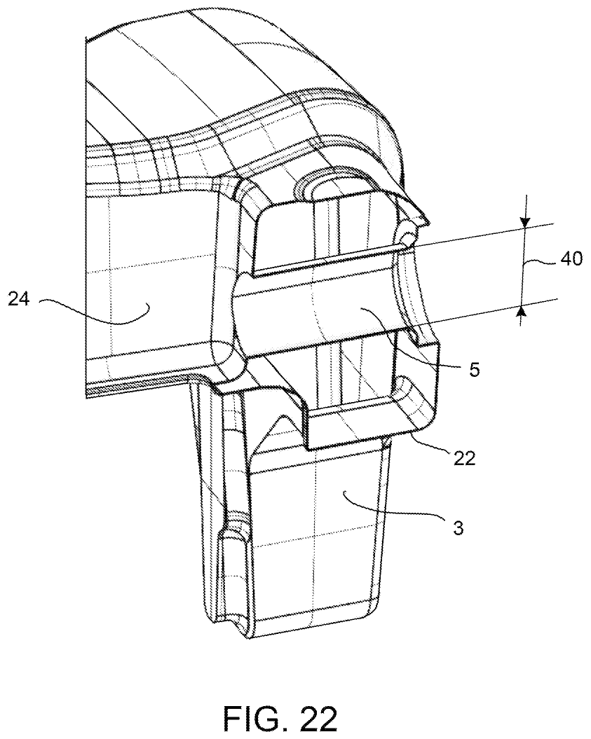

### DETAILED DESCRIPTION

A brake caliper body 3 is adapted to house thrust means to bias opposing brake pads against opposite braking surfaces of a brake disc 21 to which said caliper body 3 is adapted to be arranged in a straddling manner.

Said brake disc 21 defines an axial direction A-A, parallel to or coincident with a rotation axis X-X of said brake disc 21, a radial direction R-R, orthogonal to said rotation axis X-X, and a circumferential direction C-C which, in each intersection point between said axial direction A-A and said radial direction R-R, is orthogonal to both said axial direction A-A and said radial direction R-R.

According to a general embodiment, an assembly 1 comprises at least one covering plate 2 and one brake caliper body 3.

Said covering plate 2 comprises at least one coupling protuberance 4 which, when said covering plate 2 is separated from said brake caliper body 3, extends in a cantilevered manner from said covering plate 2.

Said brake caliper body 3 comprises at least one caliper housing 5 accommodating said coupling protuberance 4, which can take a plurality of positions when not fixed.

Said assembly 1 further comprises connecting means 6 moving from a disengaging position, which allows modifying the relative position between said coupling protuberance 4 and said caliper housing 5, to an engaging position, in which the connecting means 6 make said coupling protuberance 4 integral with said caliper housing 5.

Said connecting means 6 move from said disengaging position to said engaging position by means of a threaded member 7.

According to an embodiment, said threaded member 7 is provided in said caliper body and comprises a threaded housing 8 of threaded member made in the brake caliper body 3, which accommodates a coupling screw 9 abutting against said coupling protuberance 4, thus locking the position of said coupling protuberance 4 in the caliper housing 5.

According to an embodiment, said threaded member 7 is provided in said caliper body and comprises a threaded housing 8 of threaded member made in the brake caliper 3, which accommodates a coupling screw 9.

According to an embodiment, said coupling protuberance 4 comprises a protuberance groove 10 delimited by groove walls delimiting said protuberance groove 10.

According to an embodiment, said coupling screw 9 abuts against said groove walls, thus locking the position of said coupling protuberance 4 in the caliper housing 5.

According to an embodiment, said threaded member 7 is provided in said caliper body and comprises a threaded housing 8 of threaded member made through the brake caliper body 3, which accommodates a coupling screw 9 so that the shank of said coupling screw 9 comes out of said threaded housing 8 of threaded member.

According to an embodiment, said coupling protuberance 4 comprises a protuberance groove 10 delimited by groove walls delimiting said protuberance groove 10.

According to an embodiment, said coupling screw 9 abuts against said groove walls, thus locking the position of said coupling protuberance 4 in the caliper housing 5.

According to an embodiment, said protuberance groove 10 extends longitudinally along said coupling protuberance 4; and where said threaded housing 8 of threaded member extends with an axis orthogonal to the longitudinal extension of said protuberance groove 10.

According to an embodiment, said coupling screw 9 has a screw end 11, where said screw end 11 comprises a screw coupling form 12.

According to an embodiment, said protuberance groove 10 comprises a receiving form 13 of a shape complementary to that of said screw coupling form 12.

According to an embodiment, said coupling screw 9 has a screw end 11, where said screw end 11 comprises a conical or frustoconical screw coupling shape 12.

According to an embodiment, said protuberance groove 10 comprises a “V”-shaped receiving form 13 complementary to said screw coupling form 12.

According to an embodiment, said coupling screw 9 has a screw end 11, where said screw end 11 comprises a screw coupling form 12.

According to an embodiment, said protuberance groove 10 comprises a receiving form 13 with shape complementary to said screw coupling form 12 and delimited by receiving form walls 14.

According to an embodiment, said protuberance groove 10 comprises friction means or non-slip ridges, e.g., said receiving form walls 14 comprise friction-increasing surface knurls or corrugations between the coupling screw 9 and the protuberance groove 10.

According to an embodiment, said closing protuberance 4 comprises a free protuberance end.

According to an embodiment, said protuberance groove leads into said free protuberance end.

According to an embodiment, the coupling screw 9 comprises a screw head 15 forming a screw abutment surface 16.

According to an embodiment, said threaded housing 8 of threaded member comprises an inlet opening delimited by a threaded housing edge 17 on which said screw abutment surface 16 abuttingly rests.

According to an embodiment, said coupling screw 9 comprises a screw head 15; and where said screw head 15 comprises a screw maneuvering housing 18, e.g., a hex key housing.

According to an embodiment, said covering plate 2 comprises at least one resting protuberance 19.

According to an embodiment, said brake caliper body 3 comprises at least one caliper body resting surface 20, on which at least one resting protuberance 19 abuttingly rests.

According to an embodiment, said brake caliper boy 3 is adapted to be arranged straddling a brake disc 21, where said brake disc is adapted to rotate about a rotation axis X-X defining an axial direction A-A, either coinciding with or parallel to said rotation axis X-X, a radial direction R-R orthogonal to said rotation axis X-X, and a circumferential direction C-C which, in each intersection point between said radial direction R-E and said axial direction A-A, is orthogonal to both said radial direction R-R and said axial direction A-A.

According to an embodiment, said caliper housing 5 extends in the axial direction A-A.

According to an embodiment, the caliper housing 5 is a through housing in said brake caliper body 3.

According to an embodiment, said caliper housing 5 is provided in a wheel-side elongated element 22 of said brake caliper body 3 and is placed between two bridges 23, 24 placed straddling a brake disc 21.

According to an embodiment, said threaded housing 8 of threaded member is provided in said coupling protuberance 4 and defines a screwing axis S-S.

According to an embodiment, said coupling protuberance 4 comprises a protuberance end forming an inclined sliding plane 29, said inclined sliding plane 29 is inclined by a predetermined angle with respect to said screwing axis S-S.

According to an embodiment, the assembly 1 comprises a tightening screw 30, where said tightening screw 30 is accommodated in said threaded housing 8 of threaded member.

According to an embodiment, said tightening screw 30 comprises a tightening screw shank 31 and a tightening screw head 32; where said tightening screw shank 30 comprises a tightening screw shank diameter 33 and said tightening screw head 33 comprises a tightening screw head diameter 34.

According to an embodiment, said coupling protuberance 4 comprises said threaded housing 8 of threaded member, and said tightening screw shank 31 is accommodated in said threaded housing 8 of threaded member.

According to an embodiment, said assembly 1 comprises a sleeve 35.

According to an embodiment, said sleeve 35 comprises an outer sleeve diameter 38 and comprises a sleeve through opening 36; where said sleeve through opening 36 comprises a sleeve opening diameter 37.

According to an embodiment, the sleeve opening diameter 37 is greater than said tightening screw shank diameter 33.

According to an embodiment, said outer sleeve diameter 38 is smaller than said tightening screw head diameter, so that said sleeve 35 rests on said tightening screw head 32.

According to an embodiment, said caliper housing has a caliper housing diameter 40. Said caliper housing diameter is larger than said outer sleeve diameter 38.

According to an embodiment, said caliper housing diameter is larger than said tightening screw head diameter 34.

According to an embodiment, the sleeve 38 comprises an opposite inclined sleeve edge 39 having an inclination equal to said inclined sliding plane 29 with respect to said screwing S-S.

According to an embodiment, said sleeve 38 is fitted onto said tightening screw shank 31 and interposed between said tightening screw 32 and said inclined sliding plane 29.

According to an embodiment, said tightening screw 30, said sleeve 35, and at least part of said coupling protuberance 4 are freely received in said caliper housing 5.

According to an embodiment, said inclined sleeve edge 39 rests on said inclined sliding plane 29 so as to slide radially with respect to said screwing axis S-S upon the tightening of said tightening screw 30 so as to protrude radially with respect to said coupling protuberance 4 and interfere with said caliper housing 5 provided in the caliper body until said covering plate 2 is integral with said brake caliper body 2.

According to an embodiment, said threaded housing 8 of threaded member is provided in said coupling protuberance 4 to be coaxial to the longitudinal extension of said coupling protuberance 4.

According to an embodiment, said threaded housing 8 of threaded member provided in said coupling protuberance 4 to be parallel to the axial direction A-A.

According to an embodiment, said inclined sliding plane 29 and said inclined sleeve edge 39 are inclined with respect to said screwing axis S-S by an angle such as to allow the sleeve 35 to slide on said inclined sliding plane 29 of said coupling protuberance 4, so as to overcome the friction angle of the respective surfaces of the inclined sliding plane 29 and of said inclined sleeve edge 39.

According to an embodiment, said tightening screw shank 31 comprises a smooth shank portion 40 close to said tightening screw head 32 on which at least one portion of said sleeve 35 is fitted.

The present invention further relates to a method of mounting a covering plate 2 to a caliper body 3, comprising the steps of:
providing an assembly according to any one of the embodiments described above;
screwing said tightening screw 30 into the threaded housing 8 of threaded member provided in said coupling protuberance 4 by interposing said sleeve 35;
fitting said coupling protuberance 4, sleeve 35, and tightening screw 30 onto said caliper housing 5;
screwing the tightening screw 30 by pressing said sleeve 35 on said inclined sliding plane 29 until the sleeve 35 is also allowed to slide in the radial direction with respect to said screwing axis S-S;
continuing screwing until bringing the sleeve 35 to rest over at least one portion of the surface which delimits said caliper housing 5 and bringing said coupling protuberance 4 and/or said tightening screw head 32 to rest against at least one opposite surface portion which delimits said caliper housing 5, and locking said covering plate 2 to said brake caliper body 3.

### LIST OF REFERENCE SIGNS

1 assembly
2 covering plate
3 brake caliper body
4 coupling protuberance
5 caliper housing
6 connecting means
7 threaded member
8 threaded housing of threaded member
9 coupling screw
10 protuberance groove
11 screw end
12 screw coupling form
13 receiving form
14 receiving form walls
15 screw head
16 screw abutment surface
17 threaded housing edge
18 screw maneuvering housing
19 resting protuberance
20 caliper body resting surface
21 brake disc
22 wheel-side elongated element
23 bridge
24 bridge
29 inclined sliding plane
30 tightening screw
31 tightening screw shank
32 tightening screw head
33 tightening screw shank diameter
34 tightening screw head diameter
35 sleeve
36 sleeve through opening
37 sleeve opening diameter
38 outer sleeve diameter
39 inclined sleeve edge
40 caliper housing diameter
X-X brake disc rotation axis
A-A axial direction
R-R radial direction
C-C circumferential direction
S-S screwing axis

1. An assembly comprising, at least one covering plate and a brake caliper body;
wherein said covering plate comprises at least one coupling protuberance, which, when said covering plate is separated from said brake caliper body, extends cantilevered from said covering plate;
and wherein said brake caliper body comprises at least one caliper housing, which accommodates said coupling protuberance, which may take a plurality of positions when it is not fixed;
said assembly further comprises connecting means which pass from a disengaging position, which allows to modify the relative position between said coupling protuberance relative to said caliper housing, to an engaging position, in which the connecting means make said coupling protuberance integral with said caliper housing;
and wherein said connecting means pass from said disengaging position to said engaging position by means of a threaded member.

2. An assembly according to claim 1, wherein
said threaded member is provided in said caliper body and comprises a threaded member threaded housing made in the brake caliper body, which accommodates a coupling screw which abuts against said coupling protuberance, locking the position of said coupling protuberance in the caliper housing;
or wherein
said threaded member is provided in said caliper body and comprises a threaded member threaded housing made in the brake caliper body, which accommodates a coupling screw;
and wherein said coupling protuberance comprises a protuberance groove delimited by groove walls which delimit said protuberance groove;
and wherein said coupling screw abuts against said groove walls, locking the position of said coupling protuberance in the caliper housing;
or wherein
said threaded member is provided in said caliper body and comprises a threaded member threaded housing made passing in the brake caliper body, which
accommodates a coupling screw so that the shank of said coupling screw exits from said threaded member threaded housing;
and wherein said coupling protuberance comprises a protuberance groove delimited by groove walls which delimit said protuberance groove;
and wherein said coupling screw abuts against said groove walls, locking the position of said coupling protuberance in the caliper housing.

3. An assembly according to claim 2, wherein
said protuberance groove extends longitudinally along said coupling protuberance; and
wherein said threaded member threaded housing extends with axis orthogonal to the longitudinal extension of said protuberance groove.

4. An assembly according to claim 2, wherein
said coupling screw provides a screw end, wherein said screw end comprises a screw coupling form;
and wherein said protuberance groove comprises a receiving form whose shape is complementary to said screw coupling form;
or wherein
said coupling screw provides a screw end, wherein said screw end comprises a conical or frustum-shaped screw coupling shape;
and wherein said protuberance groove comprises a “V”-shaped receiving form whose shape is complementary to said screw coupling form;
or wherein
said coupling screw provides a screw end, wherein said screw end comprises a screw coupling form;
and wherein said protuberance groove comprises a receiving form whose shape is complementary to said screw coupling form and delimited by receiving form walls;
wherein said protuberance groove comprises friction means or non-slip reliefs, e.g., said receiving form walls comprise knurls or friction-increasing surface corrugations between the coupling screw and the protuberance groove.

5. An assembly according to claim 2, wherein
said coupling protuberance comprises a protuberance free end and wherein
said protuberance groove leads into said protuberance free end.

6. An assembly according to claim 1, wherein
said coupling screw comprises a screw head which forms a screw abutment surface;
and wherein
said threaded member threaded housing comprises an inlet opening delimited by a threaded housing edge on which said screw stop surface abuttingly rests;
and/or wherein
said coupling screw comprises a screw head; and wherein said screw head comprises a screw maneuvering housing e.g., a hex key housing.

7. An assembly according to claim 1, wherein
said covering plate comprises at least one resting protuberance; and wherein
said brake caliper body comprises at least one caliper body resting surface, on which at least one resting protuberance abuttingly rests.

8. An assembly according to claim 1, wherein
said brake caliper boy is adapted to be arranged straddling a brake disc, wherein said brake disc is adapted to rotate about a rotation axis, which defines an axial direction, either coinciding with or parallel to said rotation axis, a radial direction orthogonal to said rotation axis, and a circumferential direction which, in each intersection point between said radial direction and said axial direction is orthogonal both to said radial direction and to said axial direction;
and/or wherein
said caliper housing extends in the axial direction;
and/or wherein
said caliper housing is a through housing in said brake caliper body;
and/or wherein
said caliper housing is provided in a wheel-side elongated element of said brake caliper body and is placed between two bridges placed straddling a brake disc.

9. An assembly according to claim 1, wherein
said threaded member housing is provided in said coupling protuberance and defines a screwing axis; and wherein
said coupling protuberance comprises a protuberance end which forms an inclined sliding plane, said inclined sliding plane is inclined by a predetermined angle relative to said screwing axis; and wherein
said assembly comprises a tightening screw, wherein said tightening screw is accommodated in said threaded housing of threaded member; and wherein
said tightening screw comprises a tightening screw shank and a tightening screw head;
wherein said tightening screw shank comprises a tightening screw shank diameter and said tightening screw head comprises a tightening screw head diameter; and wherein
said coupling protuberance comprises said threaded member threaded housing and
said tightening screw shank is accommodated in said threaded member threaded housing; and wherein
said assembly comprises a sleeve; wherein
said sleeve comprises a sleeve outer diameter and comprises a sleeve through opening; wherein said sleeve through opening comprises a sleeve opening diameter;
and wherein
the sleeve opening diameter is larger than said tightening screw shank diameter; and
wherein
said sleeve outer diameter is smaller than said tightening screw head diameter, so that said sleeve rests on said tightening screw head; and wherein
said sleeve comprising a sleeve opposite inclined edge having an inclination equal to said inclined sliding plane relative to said screwing axis; and wherein
said sleeve is fitted on said tightening screw shank and interposed between said tightening screw head and said inclined sliding plane; and wherein
said tightening screw, said sleeve, and at least part of said coupling protuberance are freely received in said caliper housing; and wherein
said inclined sleeve edge rests on said inclined sliding plane so as to slide radially relative to said screwing axis upon tightening said tightening screw so as to protrude radially relative to said coupling protuberance and interfere with said caliper housing provided in the caliper body until said covering plate is integral with said brake caliper body.

10. An assembly according to claim 9, wherein
said threaded member housing is provided in said coupling protuberance coaxial to the longitudinal extension of said coupling protuberance;
or
said threaded member threaded housing (8) is provided in said coupling protuberance parallel to the axial direction.

11. An assembly according to claim 9, wherein
said inclined sliding plane and said sleeve inclined edge are inclined with respect to said screwing axis by an angle such as to allow the sleeve to slide on said inclined sliding plane of said coupling protuberance, so as to overcome the friction angle of the respective surfaces of the inclined sliding plane and of said inclined sleeve edge.

12. An assembly according to claim 9, wherein
said tightening screw shank comprises a smooth shank portion near said tightening screw head on which at least a portion of said sleeve is fitted.

13. A mounting method of a covering plate on a caliper body, comprises the steps of:
providing an assembly according to claim 9,
screwing said tightening screw interposing said sleeve into the threaded member threaded housing provided in said coupling protuberance;
fitting said coupling protuberance sleeve and tightening screw into said caliper housing;
screwing the tightening screw by pressing said sleeve on said inclined sliding plane until the sleeve can slide also in the radial direction relative to said screwing axis;
continuing screwing until the sleeve rests with at least one portion of the surface that delimits said caliper housing and making said coupling protuberance and/or said tightening screw head rest against at least one opposite portion of the surface which delimits said caliper housing and locking said covering plate to said brake caliper body.
